(19) United States
(12) Patent Application Publication
(10) Pub. No.: US 2006/0277086 A1
(43) Pub. Date: Dec. 7, 2006

(54) System and method for optimization-based production capability planning

(75) Inventors: Michael Ball, Silver Spring, MD (US); Zhenying Zhao, Ellicott City, MD (US); Yoshinori Shirasu, Kanagawa-ken (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignees: University of Maryland; Toshiba Corporation

(21) Appl. No.: 11/141,411

(22) Filed: Jun. 1, 2005

(51) Int. Cl. G06F 9/46

(52) U.S. Cl. 705/8

(57) ABSTRACT

A production capability system for automatically determining production capability quantities. The system includes a candidate generation process for generating possible production capability candidates and a quantity optimization module for calculating an optimal quantity availability for production capability candidate. The system also includes a calculation module for assigning quantities to all of the production capability candidates and means for generating a production report wherein production capability candidates and the optimal quantity are combined to generate a production capability availability which is stored in a specification for use by an external sales system. The candidate generation process and the quantity optimization module accept input data from a master database including priorities associated with different products and weights for different performance measures.

### BACKGROUND OF THE INVENTION

1. Field of the Invention

The present invention relates to a method of processing customer orders and particularly to a system and method of improving customer order promising speed and resource utilization.

2. Description of the Related Art

In sales processes, customers place orders and salespeople and/or systems need to respond to the customers' orders with a committed quantity and delivery date. In order to win business opportunities, order promising lead time, i.e., the time difference from when a customer order is received and the time a salesperson and/or system promises a specific delivery quantity and date, needs to be either immediate (near real time) or within a short time period. This is especially important for today's businesses with higher customer service expectations and competition pressures. However, firms are moving away from make-to-stock (MTS) production environments where they produce a relatively small set of standard configurations in large volumes to assemble-to-order (ATO) or configure-to-order (CTO) production environments where they produce very large varieties of products in small volumes to increase their competitive advantage. Therefore, these firms have to maintain a complex bill of materials and employ modular product designs with higher numbers of common components that can be substituted. However, in an assemble-to-order production system, it can be difficult to assess whether or not it is possible to produce certain products within a requested timeframe. This is particularly the true when a wide variety of products are offered and when each product has a large number of constituent components.

FIG. 1 illustrates the relationship of a current production capability planning (PCP) system 102 to other management modules. According to FIG. 1, sales/marketing systems 104 generate forecasted demands based on historical sales, statistical forecasting models and the judgement of salespeople. Based on the forecasted demand, a resource planning system 106 conducts various production planning processes including aggregate planning, master production scheduling, material requirement planning and capacity requirement planning to generate a material requirement plan and a capacity requirement plan via enterprise resource planning systems. Thereafter, based on the material requirement plans (MRP), procurement orders (PO) can be generated to suppliers 108. Based on POs for production execution or inventory control, suppliers 108 deliver materials/components to a factory/warehouse 110. Considering the resource availability from the suppliers and the factory/warehouse, future customer orders from sales/marketing systems and forecast demand from the enterprise resource planning system, PCP system 102 generates PC records and passes them on to the sales/marketing systems. Thereafter, when a customer 112 places an order to sale/marketing system 104, system 104 is capable of immediately responding to the order based on the PC record(s) associated with the items in that order.

A conventional method of calculating a finished product availability for sales purposes is by using the available-to-promise (ATP) quantity in a Master Production Schedule (MPS). The ATP quantity is widely used in MTS production environments since the ATP quantity provides the availability of a single finished product item. In ATO/CTO production environments, many products share common components. Therefore, in ATO/CTO environments calculating ATP quantities for environments. Moreover, in a case where a product model or family does not have a predefined bill-of-material, the ATP quantity approach is difficult to implement.

Another method of calculating finished product availability for sales purposes maps a feature set which correspond to a particular customer product configuration option to a set of required materials. In this method, a set of ratios that relate product family quantities to features are associated with product forecasts. More refined versions of this basic approach can be developed. For example, feature/product family combinations may be satisfied at different levels within a demand class.

A current production capability function, which is used in a current demand-supply control system is similar to the MPS concept in that only one product item per product candidate is allowed. For example, if product item A and product item B share a common component, the current method generates PC quantities for products A and B. Thus, in the case where procurement orders for parts common to products A and B have been placed and unique materials for each product are still procurable, the common parts must be arbitrarily allocated to products A and B, limiting the combinations of orders that can be committed. For example, assume there are two PC records, one defining Product A as including 80 units and the other defining Product B as including 20 units and material q is a common part of both products A and B. If there are 100 units of common part q and the unique materials for product B is procurable, 100 units of product B may be produced. However, the salesperson using the current production capability function is prohibited from committing to a customer inquiry of “100 units of product B” since only 20 units are set for the PC of product B. Therefore, in this approach since only one product item can be specified in each PC record, the flexibility in order promising is reduced, sales opportunities are lost and customer satisfaction is reduced.

Existing PC planning quantity calculations, such as those described above, are usually based on heuristic rules or empirical logic and are difficult to carry out quickly if detailed material and production resource availability must be checked. Additionally, these approaches generally cannot adequately reflect multiple performance measures, such as consideration of additional procurement costs, priority of a product item and/or customer, material inventory quantities and material procurement expediting and de-expediting costs.

### SUMMARY OF THE INVENTION

According to one aspect of the invention, order promising is carried out using a multi-product production capability (PC). When determining whether an order can be accepted, a salesperson or automatic order promising system would examine the PC records to determine if sufficient raw materials were available to satisfy the order. After booking an order, the PC records would be updated appropriately.

According to one aspect of the invention, there is provided a production capability system for automatically determining production capability quantities. The system includes a candidate generation process for generating possible production capability candidates and a quantity optimization module for calculating an optimal quantity availability for a set of production capability candidates. The system also includes means for generating a production report wherein production capability candidates and the optimal quantity are combined to generate a production capability availability which is stored in a specification for use by an external sales system. The candidate generation process and the quantity optimization module input data from a master database including priorities associated with different products and weights for different performance measures.

According to another aspect of the invention, there is provided a method for generating possible production quantities. The method includes the steps of generating possible production capability candidates, calculating an optimal quantity availability for a set of production capability candidates and generating a production report wherein the production capability candidates and the optimal quantity are combined to generate a production capability availability. The method further includes the step of storing the production capability availability in a specification for use by an external sales system.

According to another aspect of the invention, there is provided an apparatus for generating possible production capability quantities. The apparatus includes generating means for generating possible production capability candidates and calculating means for calculating an optimal quantity availability for a set of production capability candidates. The apparatus also includes generating means for generating a production report wherein the production capability candidates and the optimal quantity are combined to generate a production capability availability. The apparatus further includes storing means for storing the production capability availability in a specification for use by an external sales system.

According to another aspect of the invention, there is provided a computer program, embodied in a computer readable medium, for automatically determining finished product quantities. The computer program implements the steps of generating possible production capability candidates and calculating an optimal quantity availability for a set of production capability candidates. The computer program also implements the step of generating a production report wherein the production capability candidates and the optimal quantity are combined to generate a production capability availability. The computer program further implements the step of storing the production capability availability in a specification for use by an external sales system.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates the relationship of a current production capability planning system to other management modules;

FIG. 2 illustrates an embodiment of an order promising system in which an embodiment of the present invention may be implemented;

FIG. 3 illustrates how to use multiple production capabilities to promise multiple customer orders;

FIG. 4 illustrates the inventive production capability planning system that automatically determines finished product candidates based on a bill-of-materials;

FIG. 5a illustrates the major inputs and outputs of the production capability planning system;

FIG. 5b illustrates a typical bill-of-material which includes multi-levels of components and materials;

FIG. 6 illustrates the steps implemented in a production capability candidate generation module;

FIG. 7a illustrates a bill of material that include products A, B and C; and

FIG. 7b illustrates a graphical representation of the table in FIG. 5a.

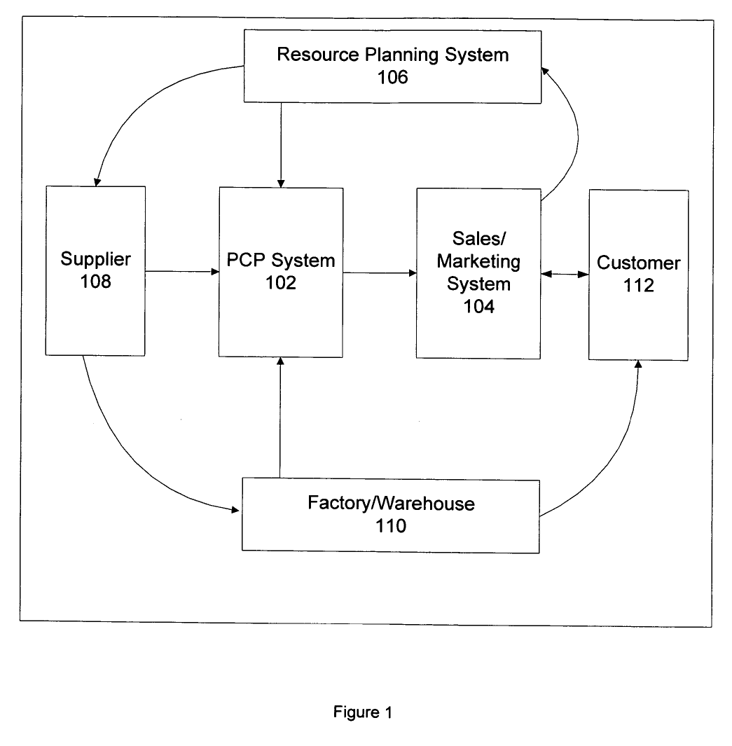

### DETAILED DESCRIPTION OF PREFERRED EMBODIMENTS

Reference will now be made to the preferred embodiments of the present invention, examples of which are illustrated in the accompanying drawings.

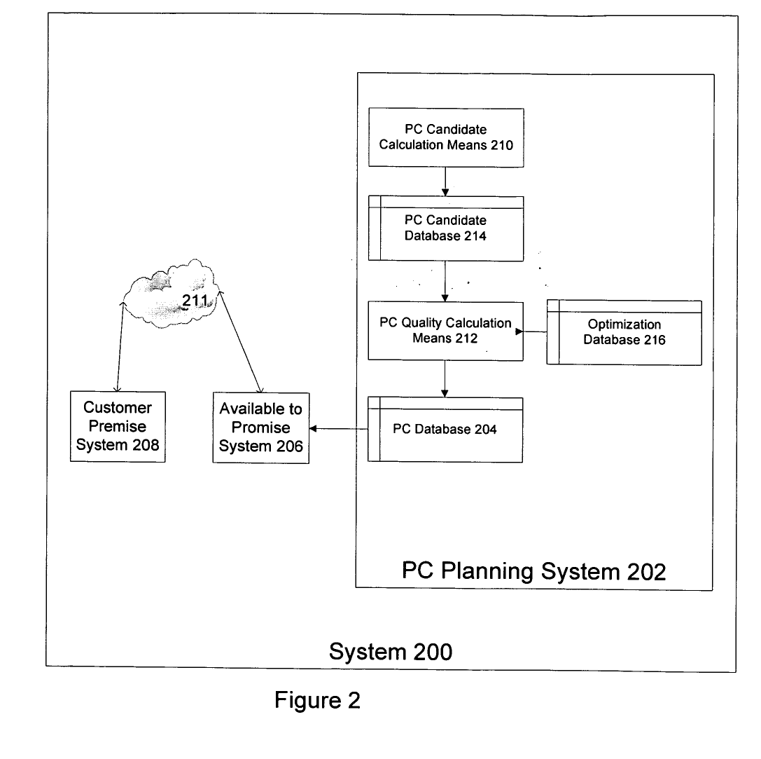

FIG. 2 illustrates an embodiment of an order promising system in which an embodiment of the present invention may be implemented. System 200 includes a PC planning system 202, an available to promise system 206 and a customer premise system 208. PC planning system 202 includes PC candidate calculation means 210, PC quantity calculation means 212, a PC candidate database 214, an optimization database 216 and a PC database 204. PC planning system 202 may be placed in a demand/supply control center and computes PCs in database 204. Customer premise system 208 is used to input a requested customer product item, a requested order quantity and a requested delivery due date. Available to promise system 206 thereafter reads the requested quantity and due dates from customer orders and provides a committed quantity and due date to the customer based on the entries in database 204. According to an embodiment of the invention, available to promise system 206 and customer premise system 208 are connected by a communications network 211, such as the Internet.

PC planning system 202 and available to promise system 206 may also include a CPU, a read only memory (ROM) or a random access memory (RAM) and an input/output (I/O) interface, each of which connects to a system bus. PC planning system 202 and available to promise system 206 may further includes an input device, a display, a communication controller, a memory device and a removable disk, wherein the input device, the display, the communication controller, the memory device and the removable disk are connected to the I/O interface. To boot PC planning system 202 and available to promise system 206, the associated CPU is configured to read and execute a boot program recorded in the ROM in response to input signals from the input device. The CPU then reads out an operating system stored in the memory device. The CPU also control operations of devices attached to the PC planning system 202 and available to promise system 206. The CPU further reads out data or programs stored in, for example, the memory device and loads them into the RAM to calculate or compute data based on the programs read out of the RAM.

The input device may be a conventional input device, such as a keyboard or mouse, wherein an operator can input commands using the input device. Input signals generated based upon an operation of the operator are received by the CPU through the I/O interface and the system bus. The display may be a cathode ray tube (CRT) display or a liquid crystal display (LCD), which receives output signals from the CPU through the system bus and the I/O interface and displays the received data, for example, a result of processes executed by the CPU. The communication control may be a LAN card or a modem and is used to connect PC planning system 202 and available to promise system 206 to a communication network such as the Internet or a LAN. The communication controller controls input and output signals transported through the communication network to the CPU through the I/O interface and the system bus. The memory device is, for example, a magnetic disk device to memory data or programs that are to be executed by the CPU. The removable disk may be an optical disk or a flexible disk. Signals read out or written into the removable disk are received or sent by the CPU through the I/O interface and the system bus.

When a salesperson or promise system 206 receives a customer order with a request for one or more products, the salesperson/system 206 must promise this customer order immediately based on quick look-up of multiple available production capabilities (PCs). As is known to those skilled in the art, different PCs may have different flexibility, available dates and/or expeditable days, so that there may be many ways to mix several PCs to promise one customer order. One embodiment of the invention provides for promising orders with single candidate PCs first, less flexible PCs second and most flexible PCs last. This is because more flexible PCs can be used to promise more products and they provide greater flexibility for handling future customer order uncertainty.

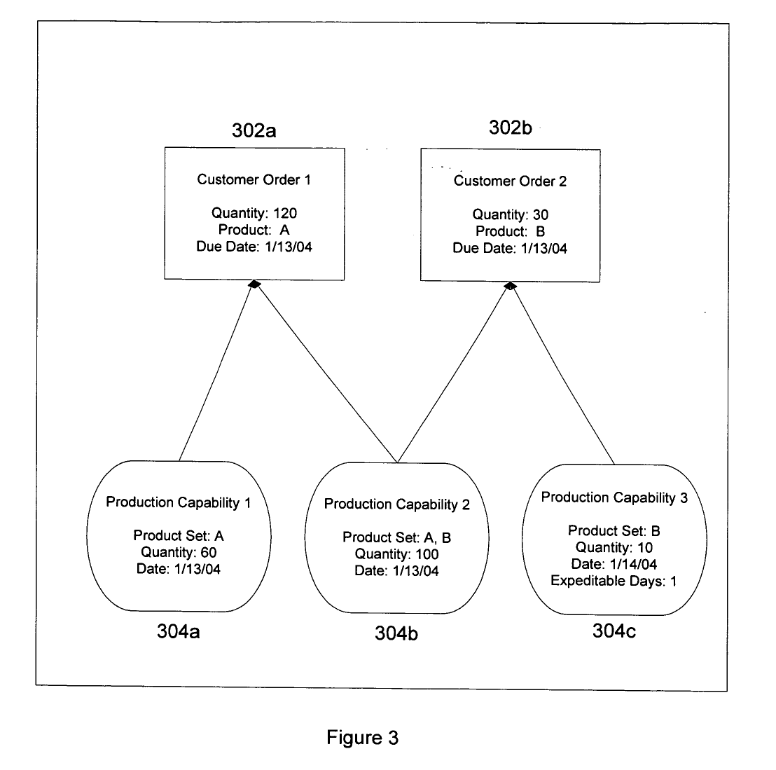

FIG. 3 illustrates how to use multiple PCs to promise multiple customer orders. According to FIG. 3, there are two customer orders 302a and 302b and three PCs 304a-304c. In customer order 302a, the customer is requesting 120 units of product A by a due date of Jan. 13, 2004 and in customer order 302b, the customer is requesting 30 units of product B by the same due date. FIG. 3 illustrates that the salesperson/system 206 has three PCs 304a-304c available to promise these two customer orders, wherein PC 304a includes a PC product set of A, a PC quantity of 60, and a PC date of Jan. 13, 2004; PC 304b includes a PC product set of product A and product B, a PC quantity of 100, and a PC date of Jan. 13, 2004; and PC 304c includes a PC product set of B, a PC quantity of 10, and a PC date of Jan. 14, 2004, and a PC expeditable date of 1. According to FIG. 3, PCs 304a and 304b cannot be expedited since they do not include a PC expeditable date value. According to an embodiment of the invention, the salesperson/system 206 may use different heuristic rules to allocate quantities from PCs 304a-304c to promise two customer orders 302a and 302b. For example, the salesperson can allocated 60 from PC 304a and 60 from PC 304b to promise customer order 302a, and 10 from PC 304c and 20 from PC 304b to promise customer order 302b. This embodiment therefore allows for more flexible PC 304b, which can be used for either product A or product B, to be kept for future/unknown customer orders.

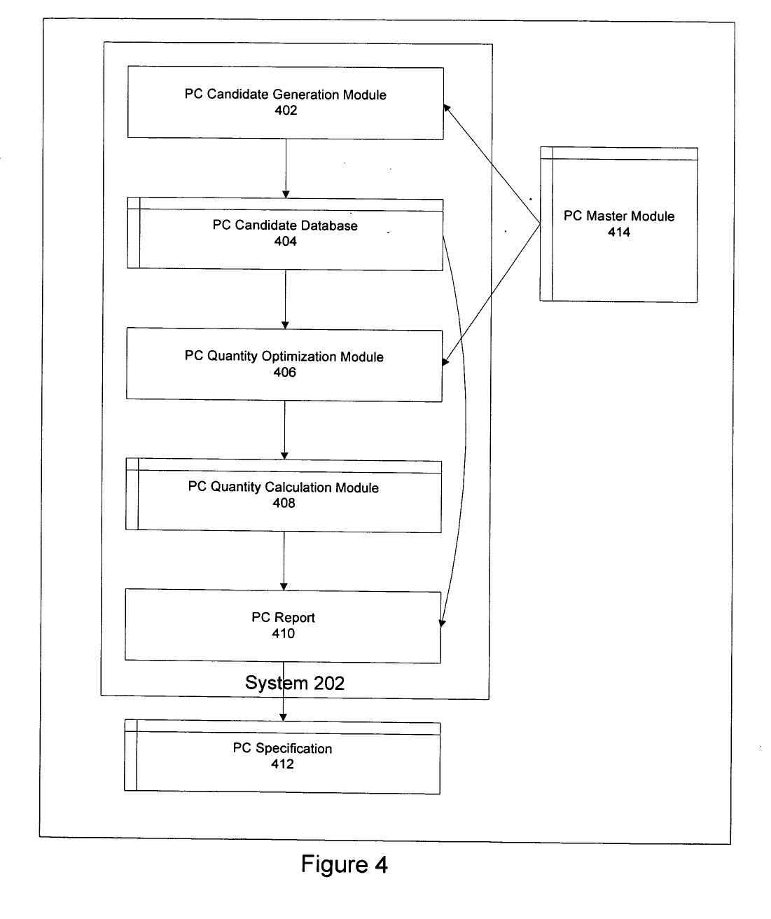

FIG. 4 further illustrates the inventive production capability planning (PCP) system 202 that automatically determines finished product candidates based on a bill-of-materials (BoM). PCP system 202 optimally calculates quantity availability for a set of product candidates in each near future time period based on resource availability and demand patterns. PCP system 202 includes a PC candidate generation module 402, a PC candidate database 404, a PC quantity optimization module 406, a PC quantity calculation module 408 a PC report 410, a PC specification 412, and a PC Master database 414. The PC candidate generation module 402 generates possible finished PC candidates and stores the results in PC candidate database 404. PC quantity optimization module 406 then calculates the optimal quantity availability for each set of generated PC candidates and PC quantity calculation module assign quantities to all of the PC candidates. System 202 then generates PC report 410 and passes the results to PC specification 412 for use by systems, such as customer premise system 208.

According to an embodiment of the invention, PC candidates include all finished products that share one or more components based on a product structure tree and strategic priorities. For example, if both product A and product B require component m, then PC candidate generation module 402 generates PC candidate (A, B). In an embodiment of the invention, PC candidate generation module 402 may eliminate or assign a lower priority to some product items. For example, product items may be assigned a lower priority if the product items are not going to be emphasized in the future. Upon generating possible finished product candidates, PC candidate generation module 402 stores the generated product candidates in PC candidate database 404.

PC quantity optimization module 406 then calculates the optimal quantity availability for each set of PC candidates generated by PC candidate generation module 402. The optimal quantity is calculated based on the resource availability and customer orders/demands by trading off various performance measures like holding costs, production capability flexibility and due date violation. The outputs from PC quantity optimization module 406 are transmitted to PC quantity calculation module 408, which assigns quantities to all of the PC candidates in PC candidate database 404 by optimizing performance measures subject to constraints. PC quantity calculation module 408 may assign zero as a quantity to indicate that the PC candidate should not be used. An embodiment of the invention allows for trading off performance measures, such as the due date violation penalty, material holding cost, additional cost for expediting of material procurement, and priorities for products using the same common parts.

Thereafter, PCP system 202 generates a PC report 410 where PC candidates and quantities are combined to generate the expected PC availability. Output from PC report 410 is stored in a PC specification 412, which is used by sales system 106. Both PC candidate generation module 402 and PC quantity optimization module 406 require inputs from a production capability master database 414, which includes the priorities associated with different products for PC planning and weights for different performance measures. For example, inputs from PC master database 414 to PC candidate generation module 402 indicate which set of product items should be emphasized by a salesperson/system at a predetermined time and which set of product items will not be produced for strategic reasons.

The inventive system provides several embodiments for selecting PC candidates and assigning a quantity for each PC candidate based on material and capacity availability. One embodiment of the invention uses a mathematical approach for PC selection and quantity assignment with a mixed integer programming (MIP) formulation. The major performance measures in the MIP formulation provides for minimizing due date violation for confirmed customer orders and enquiry orders wherein, the due date violation is equal to the number of days late times the violated quantity; maximizing the PC flexibility wherein several measures are possible—a simple possibility is the average number of finished products in all PC candidates; minimizing the inventory holding cost of all materials, components, and finished products, wherein the inventory holding cost is the held quantity of each component times the number of days held; and minimizing the additional cost for expediting procurement orders, production overtime, and outsourcing. In an embodiment, other possible performance measures could include maximization of a production smoothness measure and minimization of the number of production lots wherein the major decision variables include the assigned quantity for each PC candidate, the expeditable time window for each PC candidate with a non-zero quantity; the committed quantity for each confirmed order; the quantity reserved for each enquiry order; the assignment of all reserved or committed quantities to some PC; the regular and overtime production schedule for each production line; and the material and capacity adjustment actions including PO expedite and de-expedite, PO plan modification, outsourcing.

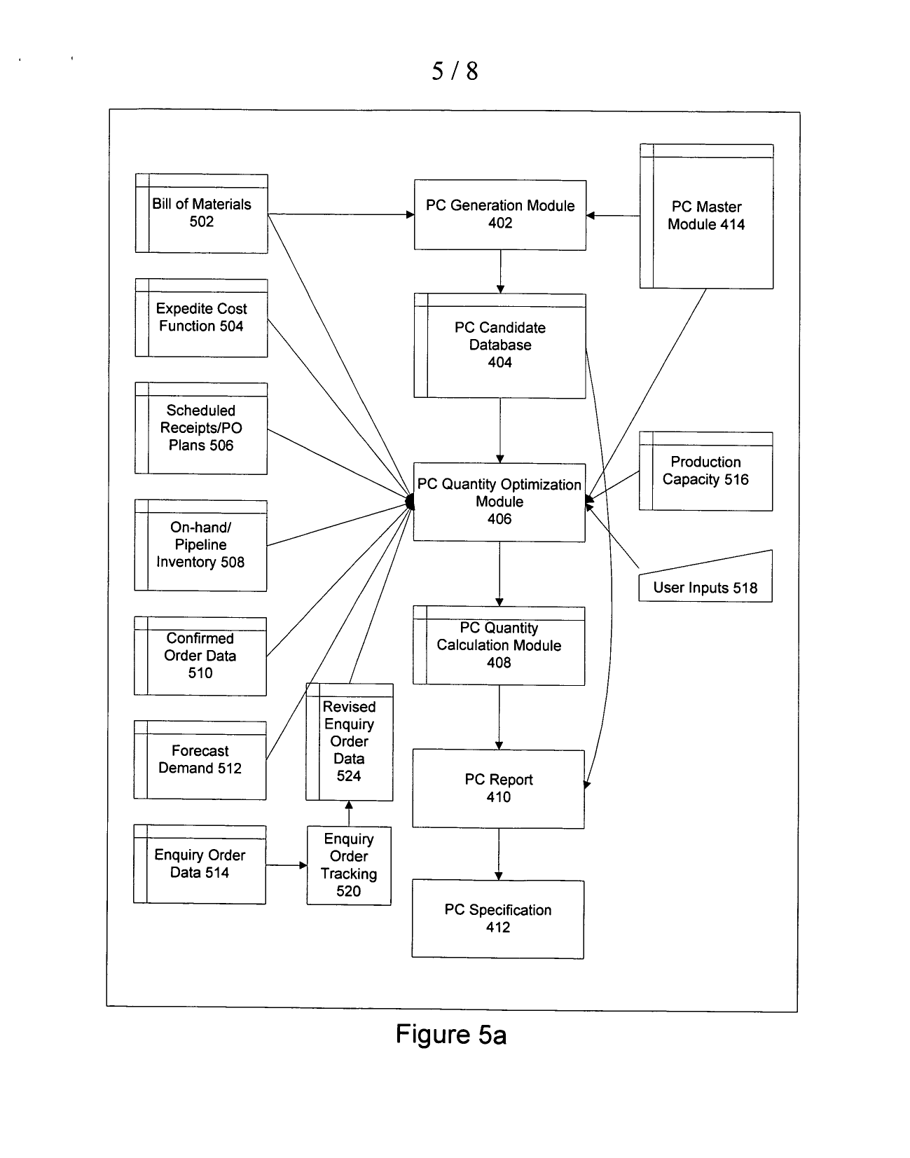

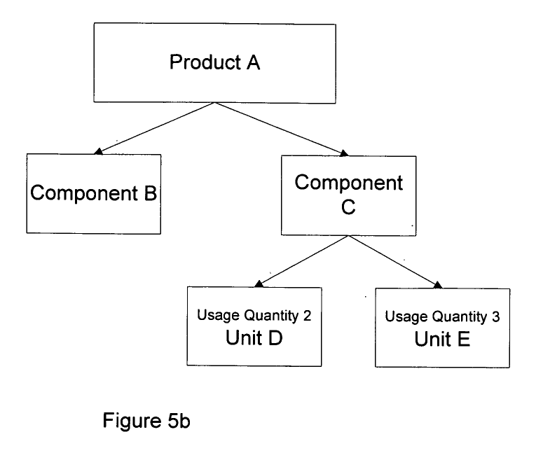

FIG. 5a illustrates the major inputs and outputs of PCP system 302. The Bill of material (BoM) in database 502 specifies the product trees of finished products, components, and purchased material. FIG. 5b illustrates a typical BoM unit, which includes multi-levels of components and materials. Each BoM unit consists of a parent item, a child item, usage quantity and the effective date of the BoM unit. As shown in FIG. 5b, a finished product A is made of two children items/components B and C and component C is made of two units of material D and three units of material E.

Returning to FIG. 5a, a BoM in database 502 is represented as a set of BoM units, each of which defines the relationship of a single parent item to multiple children items. According to the present invention, information from BoM database 502 and PC Master database 414 are the two major inputs to PC candidate generation module 402. PC Master database 414 includes information for identifying the strategies and priorities for PC planning. For example, information from PC Master database 414 identifies which confirmed customer orders need to be committed to completely and which customer order inquiries may be committed to partially. PC Master database 414 also includes weights for different performance measures, such as the flexibility of PC candidate items, PC quantities, due date violations, sales returns, material inventory holding cost, and material expedite cost. Upon receiving input from BoM database 502 and PC Master database 414, PC candidate generation module 402 generates possible finished product candidates that share common components/materials and stores the results in PC candidate database 404.

Thereafter, PC quantity optimization module 406 receives inputs from PC candidate database 404 as well as from BoM database 502, expedite cost function database 504, schedule receipts/PO plan database 506, on-hand/pipeline inventory database 508, confirmed order database 510, forecast demand database 512, enquiry order database 514, production capacity database 516 and user inputs 518 to calculate the optimal quantity availability for each set of production capability candidates generated by PC candidate generation module 402. The expedite cost function from database 504 defines the relationship between cost and delivery dates, whether or not those dates are expedited. For example, a pallet that is delivered one day earlier may cost $10 as opposed to $20 if it is delivered two days earlier. The PO plan and scheduled receipts from database 506 identify the availability of material based on plans to purchase or items purchased but not yet delivered. It includes material items, PO or receipt quantity and arrival dates. Both the PO plan and scheduled receipts can be expedited. Confirmed orders from database 510 identify orders that have been confirmed from customers and it includes ordered product items, due dates and requested quantities. Enquiry orders from database 514 identify orders that have not been confirmed. These orders are based on customer enquiries or sale people/systems estimations. Prior to entering PC quantity optimization module 406, enquiry orders are tracked thorough enquiry order tracking process 520 and compared with historical order enquiries and their realization or revisions to quantities and/or dates. Enquiry order tracking process 520 generates revised enquiry orders and stores them in revised enquiry order data module 524. Demand forecast from database 512 comes from an enterprise resource planning system. The production capacity information from database 516 includes the production line capacity for each production line in terms of the number of products that can be produced in each time bucket and the maximum cost for additional production, such as overtime or outsourcing cost.

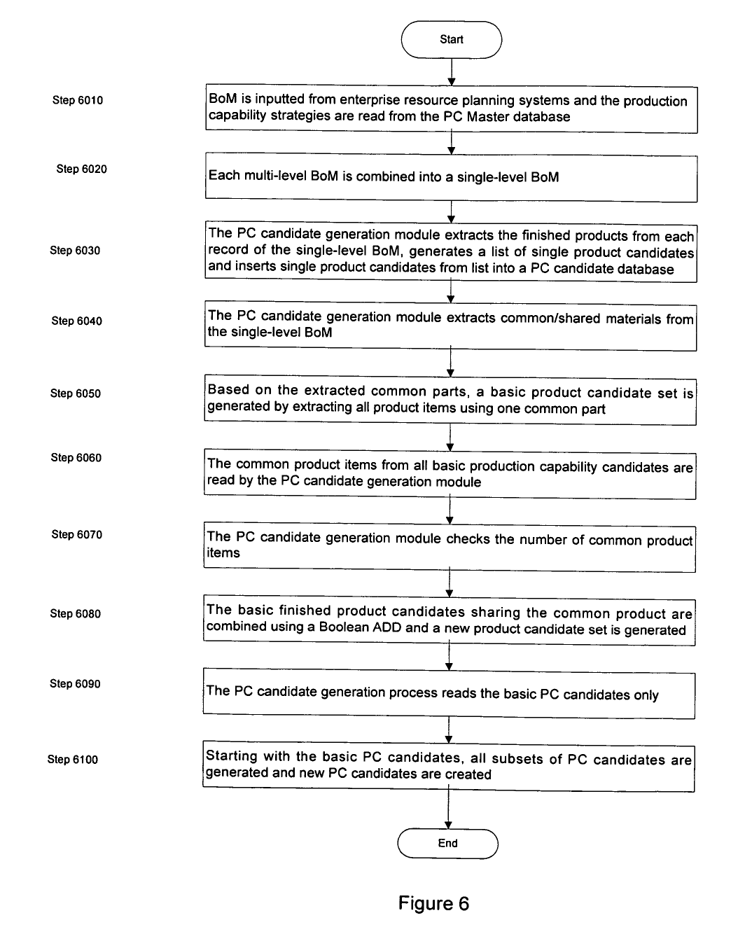

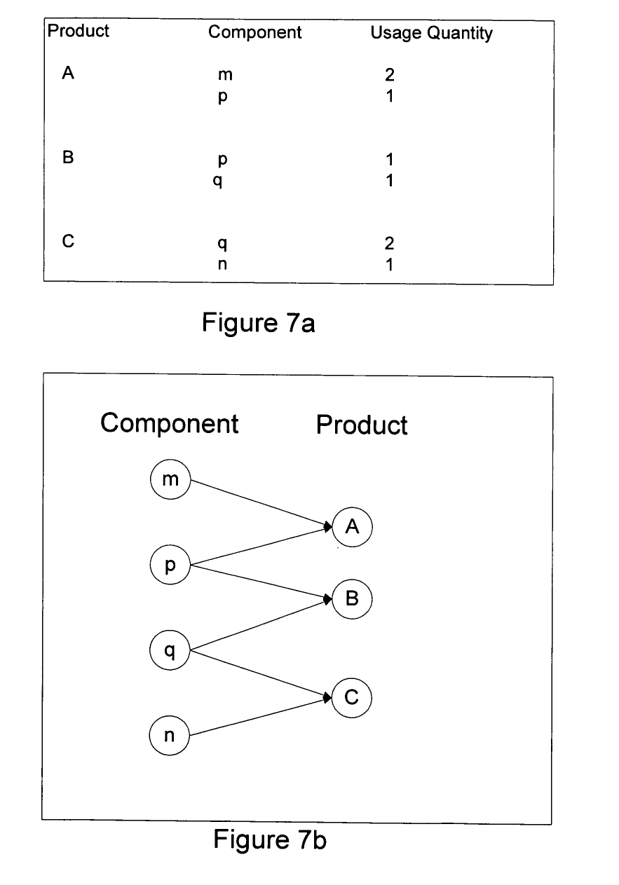

FIG. 6 illustrates the steps implemented in PC candidate generation module 402. In step 6010, BoM in database 502 is inputted from enterprise resource planning systems and the PC strategies are read from PC Master database 414. In step 6020, each multi-level BoM from database 502 is combined into a single-level BoM, which links finished products directly with purchased material items. When the single-level BoM is generated, all components in the multi-level BoM are eliminated and the single level BoM includes only finished products, purchased materials and usage quantities. In Step 6030, PC candidate generation module 402 extracts the finished products from each record of the single-level BoM, generates a list of single product candidates and inserts single product candidates from list into PC candidate database 406. For example, FIG. 7a illustrates a BoM that include products A, B and C. According to FIG. 7a, two units of material item m and one unit of material item q are required for production of finished product A; one unit of material item p and one unit of material item q are required for production of finished product B; and two units of material item q and one unit of material item n are required for production of product item C. Thus, returning to step 6030 of FIG. 6, PC candidate generation module 402 inserts product items A, B and C into PC candidate database 404 as single production capability candidates. Strategic policies extracted from PC Master database 414 are considered in step 6030. For example, a policy may designate that a specific product is not to be sold so that no product candidates will be generated from that product.

In Step 6040, PC candidate generation module 402 extracts common/shared materials from the single-level BoM. The common materials refer to materials that are used for more than one finished product in the BoM. This process can be conducted by sorting each record of the single level BoM using the material item as key. For example, FIG. 7 shows that material items p and q may be extracted as common parts since p and q are shared by finished products A, B and C. In Step 6050, based on the extracted common parts, a basic product candidate set is generated by extracting all product items using one common part. The basic production capability candidates are inserted in PC candidate database 404. FIG. 7b illustrates a graphical representation of the table in FIG. 7a. Based the illustration of FIG. 7b, in step 6050 of FIG. 6, a basic product candidate set (A, B) is generated for material item p, a basic product candidate set (B, C) is generated for material item q. The product candidate set (A, B) means that either product A or product B can be produced. According to the invention, step 6050 is repeated for all extracted common parts and the basis product candidate set is stored in PC candidate database 404. As such, PC candidate database 404 includes both the single product items and the basis product candidates.

In Step 6060, the common product items from all basic PC candidates are read by PC candidate generation module 402. For example, in a case where two PC candidates (A, B) and (B, C) are read, the common product item will be B. In step 6070, PC candidate generation module 402 checks the number of common product items. If there are common product items in all of the basic PC candidates, in step 6080, the basic finished product candidates sharing the common product are combined using a Boolean ADD and a new product candidate set is generated. Each new product candidate set is inserted in PC candidate database 404 as a super PC candidate. For example, if candidates (A, B) and (B, C) are extracted as candidate sets, a new product candidate set (A, B, C) is obtained as Boolean ADD of product set (A, B) and product candidate set (B, C). Returning to FIGS. 7a and 7b, in the case where products A and B have a common part p and products B and C have a common part q, the new product item group (A, B, C) connected by parts p and q is inserted in PC candidate database 404. Step 6080 is repeatedly executed for all product candidate sets including a predetermined product item. In Step 6090, PC candidate generation module 402 reads the basic PC candidates only. In Step 6100, starting with the basic PC candidates, all subsets of PC candidates are generated and new PC candidates are created. For example, if there is a basic PC candidate set (A, B, C), then subset PC candidates (A, B) (B, C) and (A, C) are generated in inserted into PC candidate database 404

Once processing is completed by PC candidate generation module 402 and PC optimization module 406, PC quantity calculation module 408 assigns quantities to all of the production capability candidates in PC candidate database 404 by optimizing the performance measures subject to constraints. The assigned quantity may include zero to indicate that the candidate should not be used. As such, the inventive system is able to trade off performance measures, such as due date violation penalty, additional cost for expediting and/or de-expediting of material procurement and priorities for products using the same common parts. For example, if the production capability quantities are calculated based on the BoM shown in FIG. 7b, and PC quantity calculation module 408 may assign quantities of 100 pieces to product A, 200 pieces to product B and 50 pieces product item group (A, B), which is related by common part p. In this case, PC quantity calculation module 408 generates production capabilities with high flexibility of candidate items. For example, PC quantity calculation module 408 generates production capabilities such that 150 pieces of product A and 200 pieces of product B, or 100 pieces of product A and 250 pieces of product B, or 120 pieces of product A and 230 pieces of product B may be produced.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A production capability system for automatically determining production capability quantities, the system comprising:
a candidate generation process for generating possible production capability candidates;
a quantity optimization module for calculating an optimal quantity availability for a set of production capability candidates; and
means for generating a production report wherein production capability candidates and the optimal quantity are combined to generate a production capability availability which is stored in a specification for use by an external sales system,
wherein the candidate generation process and the quantity optimization module input data from a master database including priorities associated with different products and weights for different performance measures.

2. The system of claim 1, wherein the candidate generation process generates possible production capability candidates comprising finished products that share at least one component and the candidate generation process inputs at least a bill of materials which specifies a product hierarchy of possible finished products, components and materials, wherein the finished products that share at least one component based on a product tree and strategic priorities.

3. The system of claim 1, wherein the candidate generation process eliminates some product items from the production capability candidates.

4. The system of claim 1, wherein the candidate generation process assigns a lower priority to some product items in the production capability candidates.

5. The system of claim 1, wherein the quantity optimization module calculates the optimal quantity for each set of production capability candidates based on resource availability and customer orders by trading off various performance measures.

6. The system of claim 1, wherein the quantity optimization module assigns quantities to the production capability candidates by optimizing performance measures subject to constraints.

7. The system of claim 1, further comprising selecting means for selecting production capability candidates and for assigning a quantity for each production capability candidate based on material and capacity availability.

8. The system of claim 7, wherein the selecting means comprises a mathematical selecting means with a mixed integer programming formulation, wherein performance measures in the mixed integer programming formulation provides for one of a plurality of criteria.

9. The system of claim 1, wherein the candidate generation process inputs a bill of materials comprising a parent item, at least one child item, a usage quantity of each child item and an effective date.

10. The system of claim 1, wherein the candidate generation process is configured to store the possible production capability candidates in a candidate module, wherein the quantity optimization module retrieves the possible production capability candidates from the candidate module prior to calculating an optimal quantity availability for each set of production capability candidates.

11. The system of claim 1, wherein the quantity optimization module inputs at least one of a bill of materials, an expedite cost function, schedule receipts, a purchase order plan, an on-hand inventory, a confirmed order, a forecasted demand, an enquiry order, a production capacity and user inputs prior to calculating an optimal quantity availability for each set of production capability candidates.

12. The system of claim 11, wherein the expedite cost function defines a relationship between cost and delivery dates.

13. The system of claim 11, wherein the scheduled receipts and purchase order plan identify an availability of material based at least on one of plans to purchase or undelivered purchased materials.

14. The system of claim 11, wherein the confirmed order identify orders that have been confirmed from a customer;

15. The system of claim 11, wherein the enquiry order identify orders that have not been confirmed, wherein enquiry orders are compared with historical order enquiries and associated realization or revisions prior to entering the quantity optimization module.

16. A method for automatically determining production capability quantities, the method comprising the steps of:
generating possible production capability candidates;
calculating an optimal quantity availability for a set of production capability candidates;
generating a production report wherein the production capability candidates and the optimal quantity are combined to generate a production capability availability; and
storing the production capability availability in a specification for use by an external sales system.

17. The method of claim 16, further comprising the steps of:
inputting a bill of materials from an external system through an associated database;
combining a multi-level bill of materials into a single level bill of materials, wherein the single level bill of materials links finished products directly with purchased material items;
extracting the finished products from each record in the single level bill of materials to thereby generate a list of single product candidates;
extracting shared materials from the single level bill of materials;
generating a basic product candidate set by extracting all product items using one common part;
reading a common product item for all basic product candidates in the basic product candidate set and checking a number of common product items, wherein if there is a common product item in all of the basic product candidates, combining the basic product candidates to generate a new product candidate set;
repeating the step of reading for all product candidate sets including a predetermined product item; and
reading the basic production capability candidates and generating new production capability candidates.

18. The method of claim 17, wherein the step of extracting the finished products comprises sorting each record of the single level bill of materials using a material item as a key.

19. An apparatus for generating possible production capability quantities, the apparatus comprising:
generating means for generating possible production capability candidates;
calculating means for calculating an optimal quantity availability for a set of production capability candidates;
generating means for generating a production report wherein the production capability candidates and the optimal quantity are combined to generate a production capability availability; and
storing means for storing the production capability availability in a specification for use by an external sales system.

20. A computer program, embodied in a computer readable medium, for automatically determining finished product quantities by implementing the steps of:
generating possible production capability candidates;
calculating an optimal quantity availability for a set of production capability candidates;
generating a production report wherein the production capability candidates and the optimal quantity are combined to generate a production capability availability; and
storing the production capability availability in a specification for use by an external sales system.
